(19) United States
(12) Patent Application Publication
(10) Pub. No.: US 2013/0255260 A1
(43) Pub. Date: Oct. 3, 2013

(54) RESONANCE DAMPER FOR DAMPING ACOUSTIC OSCILLATIONS FROM COMBUSTOR

(71) Applicants: Daniel W. Carey, San Diego, CA (US); Leonel O. Arellano, Poway, CA (US); Stuart A. Greenwood, San Diego, CA (US)

(72) Inventors: Daniel W. Carey, San Diego, CA (US); Leonel O. Arellano, Poway, CA (US); Stuart A. Greenwood, San Diego, CA (US)

(73) Assignee: Solar Turbines Inc., San Diego, CA (US)

(21) Appl. No.: 13/433,790

(22) Filed: Mar. 29, 2012

(51) Int. Cl. F02C 7/24

(52) U.S. Cl. 60/725

(57) ABSTRACT

A resonance damper for damping acoustic oscillations within a combustor housing of a gas turbine engine is provided. The resonance damper comprises a baffle plate, multiple openings, and multiple tubes. The baffle plate is configured to be attached to an interior wall of the combustor housing. The baffle plate defines a cavity with the interior wall of the combustor housing. The openings are provided on the baffle plate. Each of the tubes is received within each of the openings to define the resonance damper with the cavity.

### TECHNICAL FIELD

The present disclosure relates to a resonance damper for damping acoustic oscillations, and more particularly to a resonance damper for damping acoustic oscillations within a combustor housing of a gas turbine engine.

### BACKGROUND

A resonance damper is provided in a gas turbine engine to damp acoustic oscillations produced by components within the engine thus avoiding detrimental effects to the service and life of the gas turbine engine. European Published Application No. 1624251 relates to a method for absorbing thermo acoustic vibrations, especially in the combustion chamber of a gas turbine engine. The method uses at least one Helmholtz resonator of a fixed volume. The Helmholtz resonator is connected to the combustion chamber via a duct.

### SUMMARY

In one aspect, the present disclosure provides a resonance damper for damping acoustic oscillations within a combustor housing of a gas turbine engine. The resonance damper comprises a baffle plate, multiple openings, and multiple tubes. The baffle plate is configured to be attached to an interior wall of the combustor housing. The baffle plate defines a cavity with the interior wall of the combustor housing. The openings are provided on the baffle plate. Each of the tubes is received within each of the openings to define the resonance damper with the cavity.

In another aspect, the present disclosure provides a combustor housing of a gas turbine engine. The combustor housing comprises a combustor, and the resonance damper for damping the acoustic oscillations within the combustor housing. The combustor produces acoustic oscillations. The resonance damper comprises the baffle plate, multiple openings, and multiple tubes. The baffle plate is configured to be attached to an interior wall of the combustor housing. The baffle plate defines the cavity with the interior wall of the combustor housing. The openings are provided on the baffle plate. Each of the tubes is received within each of the openings to define the resonance damper with the cavity.

In another aspect, the present disclosure provides a gas turbine engine including a compressor system, multiple injectors, and the combustor housing. The injectors are adapted to receive compressed air from the compressor system. The injectors are further adapted to supply fuel and air to the combustor. The combustor housing includes the combustor, and the resonance damper for damping the acoustic oscillations within the combustor housing. The combustor is operatively connected to the injectors. The combustor is configured to receive and combust the fuel and air thereby producing acoustic oscillations. The resonance damper comprises the baffle plate, multiple openings, and multiple tubes. The baffle plate is configured to be attached to the interior wall of the combustor housing. The baffle plate defines the cavity with the interior wall of the combustor housing. The openings are provided on the baffle plate. Each of the tubes is received within each of the openings to define the resonance damper with the cavity.

Other features and aspects of this disclosure will be apparent from the following description and the accompanying drawings.

### BRIEF DESCRIPTION OF THE DRAWINGS

FIG. 1 is a sectional view of a gas turbine engine in accordance with an embodiment of the present disclosure;

FIG. 2 is a sectional view of a combustor housing of the gas turbine engine of FIG. 1;

FIG. 3 is a front view of a baffle plate with multiple openings and tubes; and

FIG. 4 is a sectional view of the baffle plate of FIG. 3.

### DETAILED DESCRIPTION

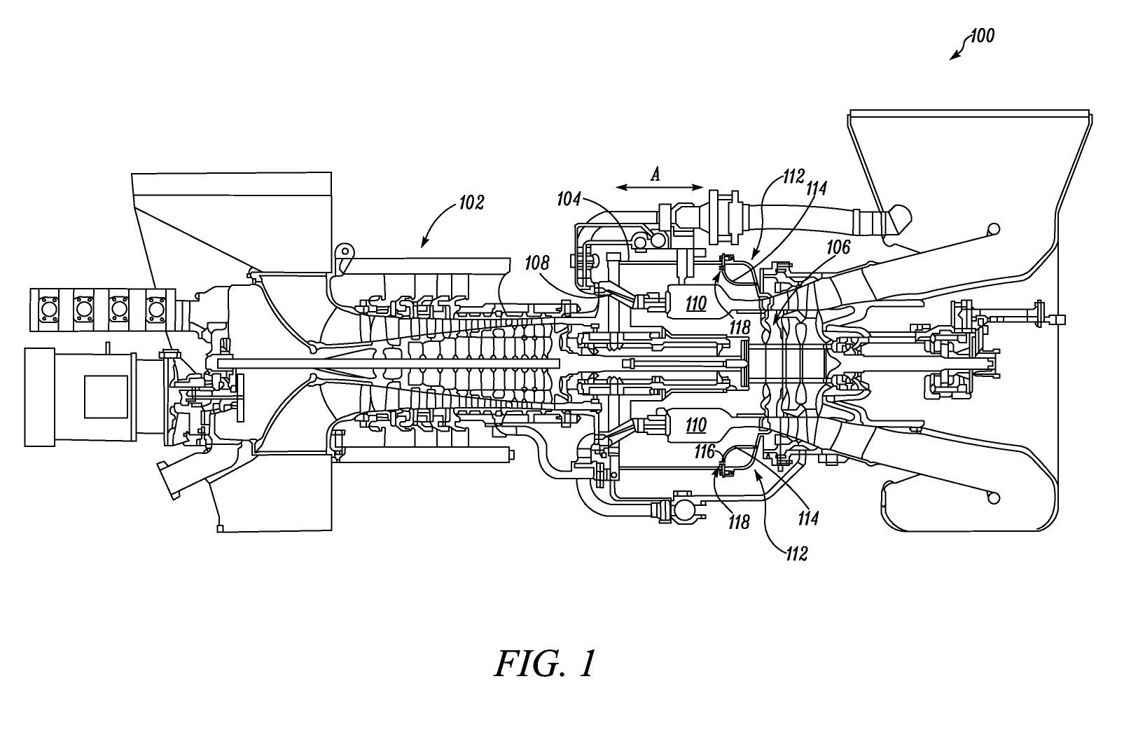

The present disclosure relates to a resonance damper for damping acoustic oscillations within a combustor housing of a gas turbine engine. FIG. 1 shows a sectional view of a gas turbine engine 100 in which disclosed embodiments may be implemented. The gas turbine engine 100 may be of any type. In one embodiment, the gas turbine engine 100 may be an industrial turbine engine, for example, but not limited to, an axial flow turbine used for power generation or driving mechanical assemblies, or in jet propulsion systems. As shown in FIG. 1, the gas turbine engine 100 may embody an axial flow industrial turbine which may be used for power generation.

As shown in FIG. 1, the gas turbine engine 100 includes a compressor system, a combustor housing 104, and a turbine system 106. The compressor system 102 is provided to compress air and operatively provide the compressed air to various components of the gas turbine engine 100. The compressor system 102 may be, but not limited to, a rotary compressor. Further, the compressor system 102 may be a single stage or a multistage compressor. In FIG. 1, the compressor system 102 may embody a multistage rotary compressor. The gas turbine engine 100 further includes multiple injectors 108 adapted to receive compressed air from the compressor system 102. Further, the injectors 108 may be adapted to supply a mixture of fuel and air.

Further, as shown in FIG. 1, the combustor housing 104 includes a combustor 110 and a resonance damper 112. The combustor 110 is disposed within the combustor housing 104 of the gas turbine engine 100 and is operatively connected to multiple injectors 108. The injectors 108 supply the mixture of fuel and air to the combustor 110. Furthermore, the combustor 110 may also receive compressed air directly from the compressor system 102. The combustor 110 receives and combusts the mixture of fuel and air to generate energy. This energy may be utilized to drive the turbine system 106 which may in turn use some part of the energy in driving the compressor system 102 while concurrently using the remaining part of the energy to do work. During combustion of the mixture of fuel and air by the combustor 110, some of the energy is released in the form of acoustic energy. This acoustic energy may be manifested as acoustic oscillations in an axial or circumferential direction within the combustor housing 104 as is known to persons having ordinary skill in the art. Further, as shown in FIG. 1, the resonance damper 112 includes a baffle plate 114, multiple openings 116, and multiple tubes 118. The resonance damper 112 is configured to damp the acoustic oscillations within the combustor housing 104. In one embodiment, the resonance damper 112 is configured to damp the acoustic oscillations travelling in an axial direction A within the combustor housing 104.

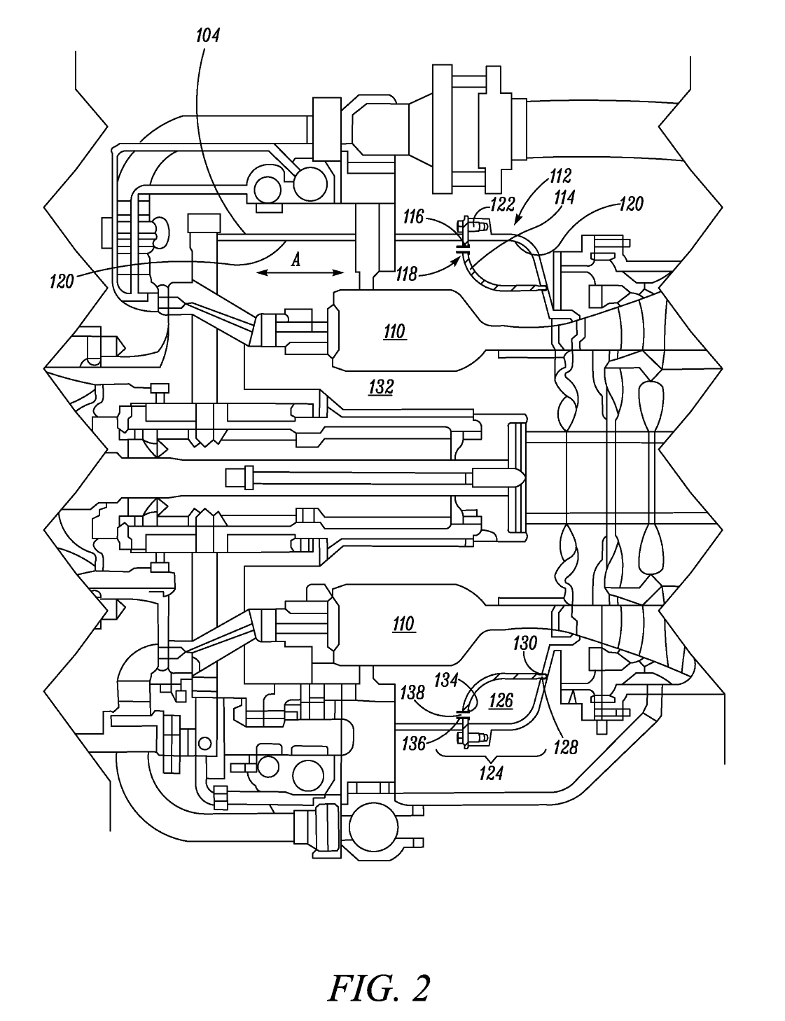

FIG. 2 shows a sectional view of the combustor housing 104 present in the gas turbine engine 100. The baffle plate 114 is configured to be attached to an interior wall 120 of the combustor housing 104. In the embodiment as shown in FIG. 2, the baffle plate 114 is rigidly attached to the interior wall 120 of the combustor housing 104 by fasteners 122. The fasteners 122 may be, for example, a bolting arrangement, rivets, or welded joints. However, a person having ordinary skill in the art will appreciate that the attachment of the baffle plate 114 to the interior wall 120 of the combustor housing 104 by the bolting arrangement, rivets, or welded joints is only exemplary in nature and that any other method known in the art may be used to attach the baffle plate 114 to the interior wall 120 of the combustor housing 104.

In an embodiment as shown in FIG. 2, the baffle plate 114 is configured to be attached to the interior wall 120, at a posterior portion 124, of the combustor housing 104. The baffle plate 114 defines a cavity 126 with the interior wall 120 at the posterior portion 124 of the combustor housing 104. In this embodiment, the baffle plate 114 is annular in shape and has a substantially L-shaped cross-section. Further, in this embodiment, the baffle plate 114 includes an annular edge 128 configured to be received in an annular groove 130 defined within the combustor housing 104. Typically, the shape of the baffle plate 114 is selected based on various constraints imposed by a spatial geometry and construction of the combustor housing 104. Further, the shape of the baffle plate 114 is chosen such that the baffle plate 114 together with the interior wall 120 of the combustor housing 104 defines the cavity 126 with a desired resonance volume. As understood by a person having ordinary skill in the art, various constraints in the shape of the baffle plate 114 stem from the points of attachment that are feasible with the combustor housing 104 and also the presence of other components present within the combustor housing 104 of the gas turbine engine 100. Furthermore, the shape of the baffle plate 114 may be chosen such that, the shape of the baffle plate 114 influences a flow-field pattern of the acoustic oscillations within the combustor housing 104 and dampen these acoustic oscillations. However, a person having ordinary skill in the art will appreciate that the baffle plate 114 being annular in shape and having a substantially L-shaped cross-section is only exemplary in nature and that any other suitable shape and cross-section known in the art may be used to form the baffle plate 114.

Further as shown in FIG. 2, multiple openings 116 are provided on the baffle plate 114. Each of the tubes 118 is received within an opening 116 to define the resonance damper 112 with the cavity 126. The number of openings 116 provided on the baffle plate 114 may vary based on the number of tubes 118 to be received therein. Further, the openings 116 are intermittently spaced from one another based on a pre-determined flow-field pattern or mode-shapes of the acoustic oscillations within the combustor housing 104. Furthermore, the number of tubes 118 may be chosen such that a required amount of resonance damping is achieved by providing an optimal amount of acoustic connectivity between an interior 132 of the combustor housing 104 and the cavity 126.

In the embodiment as shown in FIG. 2, each of the tubes 118 may include a lip 134 and a longitudinal body 136 extending from the lip 134. In this embodiment, the lip 134 of the tube 118 may be configured to abut against the baffle plate 114. Further, the longitudinal body 136 defines a throat 138 configured to allow passage of the acoustic oscillations into the cavity 126. Thus, the openings 116 and the tubes 118 received therein may optimize a through-flow of the acoustic oscillations between the interior 132 of the combustor housing 104 and the cavity 126 via the throat 138.

In the preceding embodiments, the tube 118 may be of a circular cross-section, square cross-section, tapered, bent, with flanged ends, and the like. Further, in another embodiment, a length and a cross section of the tube 118 may be selected based on a length and a cross sectional area of the throat 138 required. A person having ordinary skill in the art will acknowledge that the shape, the length and the cross-section of the tube 118 may be selected to facilitate easy assembly of the tube 118 into the combustor housing 104 without hindering the function of the resonance damper 112 in an assembled state.

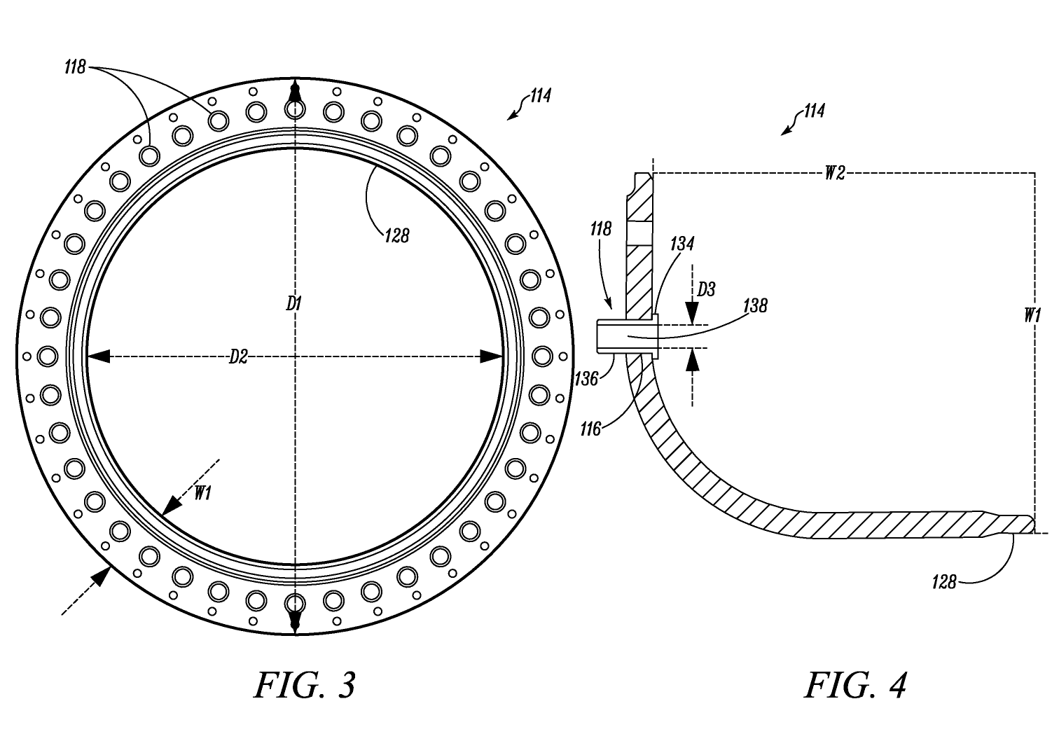

In an exemplary embodiment as shown in FIGS. 3 and 4, the baffle plate 114 may have an outer diameter D1 of 100 inches and the annular edge 128 defining an inner diameter D2 of 90 inches. Hence, a top-face width W1 of the baffle plate 114 is 5 inches. Multiple openings 116, for example, 40 openings 116 may be provided on the top-face width W1. Each of the openings 116 may be approximately 2 inches in diameter through which the longitudinal body 136 of each tube 118 may be received. The longitudinal body 136 of each of the tubes 118 may define the throat 138 with a diameter D3 of 1.5 inches. In this embodiment, the baffle plate 114 when attached to the interior wall 120, at the posterior portion 124, of the combustor housing 104 may define the cavity 126 with a width W2 of 4 inches. The resonance damper 112 constituted by the aforesaid arrangement and choice of dimensions may dampen acoustic oscillations in a frequency range of, for example, approximately 150-190 Hertz. However, it is to be understood that all the dimensions and the number of openings 116 and tubes 118 mentioned in the above embodiment are only exemplary in nature. Furthermore, a person having ordinary skill in the art will acknowledge that these dimensions and number of openings 116 and tubes 118 may change depending on the constraints in design of the baffle plate 114, as discussed earlier, along with the frequencies of the acoustic oscillations that require damping.

### INDUSTRIAL APPLICABILITY

When the mixture of fuel and air is combusted in the combustor 110, energy is generated. A component of this energy may be released as acoustic energy which may manifest itself in the form of acoustic oscillations. As already known to a person having ordinary skill in the art, these acoustic oscillations are a type of mechanical wave that propagate with the help of a fluid medium present within the combustor 110 and the combustor housing 104. Generally, the fluid medium present within the combustor 110 is the mixture of fuel and air while the fluid medium present within the combustor housing 104 is air.

The acoustic oscillations radiating from the combustor 110 reflect away from the interior walls 120 of the combustor housing 104 thus moving successively to and fro within the combustor housing 104. There is a possibility that two or more acoustic oscillations may undergo constructive interference thus increasing the amplitude of the resulting acoustic oscillation, also known as, dynamic pressure oscillation.

As known to a person having ordinary skill in the art, many components in the combustor housing 104 have a natural frequency of vibration. When a frequency of acoustic oscillations or dynamic pressure oscillations matches the natural frequency of any component within the combustor housing 104, the specified component may undergo vibrations and subsequently fail. Further, if the frequency of acoustic oscillations or dynamic pressure oscillations matches the natural frequency of the combustor housing 104, the combustor housing 104 itself may fail. Hence, the combustor housing 104 and the components present therein need to be protected from prolonged exposure to the acoustic oscillations or the dynamic pressure oscillations. Further, fluctuations in the amplitude of the dynamic pressure oscillations can be large enough to cause failure of the combustor housing 104 and the components present therein. Furthermore, the fluctuations in the amplitude of the dynamic pressure oscillations may, at the very least, reduce the service life of the combustor housing 104 and the components present therein, even if the frequency of the acoustic oscillation is substantially different from the natural frequency of the combustor housing 104 and the components therein. Failure of the components or the combustor housing 104 may be detrimental to the safe operation of the gas turbine engine 100 and hence, damping of acoustic oscillations or dynamic pressure oscillations to safe and acceptable limits may be required.

Further, as known to a person having ordinary skill in the art, a fluid medium, for example, air, exists in the combustor housing 104. The resonance damper 112 may be analogous to a spring mass damper system, wherein the air in the throat 138 of the longitudinal body 136 acts as a mass in the spring mass damper system while the air in the cavity 126 acts as a spring in the spring mass damper system. Frictional forces between the air in the throat 138 and the walls of the throat 138 act to dampen the dynamic pressure oscillations outside the resonance damper 112 while the air in the cavity 126 acts as a resilient spring to phase-shift and cause destructive interference among successive dynamic pressure oscillations. Hence, dynamic pressure oscillations are effectively damped by the resonance damper 112. More specifically, the baffle plate 114 and the cavity 126 together may functionally be analogous to multiple Helmholtz resonators arranged in an annular pattern to damp out dynamic pressure oscillations within the combustor housing 104. Hence, the baffle plate 114 and the cavity 126 together with the tubes 118 may be used to uniformly bleed air from within the combustor housing 104 for stability control of the gas turbine engine 100.

The use of the resonance damper 112 in the gas turbine engine 100 may allow smoother operation of the gas turbine engine 100. Further, the use of resonance dampers 112 in a gas turbine engine 100 may result in lower maintenance costs by avoiding frequent repairs and replacement of components within the gas turbine engine 100 otherwise impacted by large acoustic oscillations or dynamic pressure oscillations. Furthermore, down times required for repairs and replacement of components within the gas turbine engine 100 may be reduced. Hence, the resonance damper 112 may increase overall productivity and profitability associated with the gas turbine engine 100.

Furthermore, existing combustor housing structures such as cavities or flow distribution baffles could be used to construct the resonance damper 112 within the combustor housing 104. For example, in an existing baffle plate 114 with openings 116, tubes 118 can be inserted into the openings 116 to define the resonance damper 112 disclosed in the above embodiments. The compact construction and configuration of parts of the resonance damper 112 make it retrofittable, since existing structures and cavities can be repurposed for acoustic damping purposes. Thus, the resonance damper 112 and subsequently the gas turbine engine 100 may be quickly set up with minimal effort and modifications saving time and expense.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A resonance damper for damping acoustic oscillations within a combustor housing of a gas turbine engine, the resonance damper, comprising:
a baffle plate configured to be attached to an interior wall of the combustor housing, and define a cavity with the interior wall of the combustor housing;
a plurality of openings provided on the baffle plate; and
a plurality of tubes received within each of the plurality of openings to define the resonance damper with the cavity.

2. The resonance damper of claim 1, wherein each of the tubes comprises a lip and a longitudinal body extending from the lip.

3. The resonance damper of claim 2, wherein the lip of the tube abuts against the baffle plate.

4. The resonance damper of claim 2, wherein the longitudinal body defines a throat configured to allow passage of the acoustic oscillations into the cavity.

5. The resonance damper of claim 1, wherein the baffle plate is configured to be attached to the interior wall, at a posterior portion, of the combustor housing.

6. The resonance damper of claim 5, wherein the baffle plate is annular in shape and has a substantially L-shaped cross-section.

7. The resonance damper of claim 6, wherein the baffle plate includes an annular edge configured to be received in an annular groove defined within the combustor housing.

8. A combustor housing of a gas turbine engine comprising:
a combustor producing acoustic oscillations; and
a resonance damper for damping the acoustic oscillations within the combustor housing, the resonance damper comprising:
a baffle plate configured to be attached to an interior wall of the combustor housing, and define a cavity with the interior wall of the combustor housing;
a plurality of openings provided on the baffle plate; and
a plurality of tubes received within each of the plurality of openings to define the resonance damper with the cavity.

9. The combustor housing of claim 8, wherein each of the tubes comprises a lip and a longitudinal body extending from the lip.

10. The combustor housing of claim 9, wherein the lip of the tube abuts against the baffle plate.

11. The combustor housing of claim 9, wherein the longitudinal body defines a throat configured to allow passage of the acoustic oscillations into the cavity.

12. The combustor housing of claim 8, wherein the baffle plate is configured to be attached to an interior wall, at a posterior portion, of the combustor housing.

13. The combustor housing of claim 12, wherein the baffle plate is annular in shape and has a substantially L-shaped cross-section.

14. The combustor housing of claim 13, wherein the baffle plate includes an annular edge configured to be received in an annular groove defined within the combustor housing.

15. A gas turbine engine comprising:
a compressor system;
a plurality of injectors adapted to receive compressed air from the compressor system, the plurality of injectors further adapted to supply a mixture of fuel and air; and
a combustor housing including:
a combustor operatively connected to the plurality of injectors, the combustor configured to receive and combust the mixture of fuel and air, wherein the combustor produces acoustic oscillations; and
a resonance damper for damping the acoustic oscillations within the combustor housing, the resonance damper comprising:
a baffle plate configured to be attached to an interior wall of the combustor housing, and define a cavity with the interior wall of the combustor housing;
a plurality of openings provided on the baffle plate; and
a plurality of tubes received within each of the plurality of openings to define the resonance damper with the cavity.

16. The gas turbine engine of claim 15, wherein each of the tubes comprises a lip and a longitudinal body extending from the lip.

17. The gas turbine engine of claim 16, wherein the lip of the tube abuts against the baffle plate.

18. The combustor housing of claim 16, wherein the longitudinal body defines a throat configured to allow passage of the acoustic oscillations into the cavity.

19. The gas turbine engine of claim 15, wherein the baffle plate is configured to be attached to an interior wall, at a posterior portion, of the combustor housing.

20. The combustor housing of claim 19, wherein the baffle plate is annular in shape and has a substantially L-shaped cross-section.

21. The combustor housing of claim 20, wherein the baffle plate includes an annular edge configured to be received in an annular groove defined within the combustor housing.
